(19) United States
(12) Patent Application Publication
(10) Pub. No.: US 2020/0230571 A1
(43) Pub. Date: Jul. 23, 2020

(54) MESOPOROUS SILICA AND STATIONARY PHASES AND SOLID PHASE SORBENTS THEREFROM

(71) Applicants: ABUZAR KABIR, DHAKA (BD); KENNETH G. FURTON, HOMESTEAD, FL (US)

(72) Inventors: ABUZAR KABIR, DHAKA (BD); KENNETH G. FURTON, HOMESTEAD, FL (US)

(73) Assignee: THE FLORIDA INTERNATIONAL UNIVERSITY BOARD OF TRUSTEES, MIAMI, FL (US)

(21) Appl. No.: 16/252,829

(22) Filed: Jan. 21, 2019

(51) Int. Cl. B01J 20/10; B01J 20/28; B01J 20/291; B01J 20/32; B01J 20/30; B01D 15/10; B01D 53/02; B01J 20/26; C01B 33/18

(52) U.S. Cl. CPC B01J 20/103; C01P 2002/88; B01J 20/28064; B01J 20/28073; B01J 20/28076; B01J 20/28016; B01J 20/291; B01J 20/3204; B01J 20/3272; B01J 20/3293; B01J 20/3085; B01J 20/3078; B01J 20/3021; B01D 15/10; B01D 53/025; B01J 20/262; C01B 33/18; B01D 2253/106; B01D 2253/25; B01J 2220/46; B01J 2220/52; C01P 2006/16; C01P 2006/12; C01P 2006/14; B01J 20/28083

(57) ABSTRACT

A method to form mesoporous silica by a sol-gel process that has an acid catalyzed hydrolysis and the base catalyzed condensation of one or more tetraalkoxysilane that gives mesoporous silica and larger pores and high pore volumes. The mesoporous silica is surface modified by a sol-gel process that has an acid catalyzed hydrolysis and condensation of a methyltrialkoxysilane and a substituted trialkoxysilane and/or a hydroxy substituted inorganic or organic polymer to form gel coated mesoporous silica particles having functionality for use as chromatographic supports or a solid phase sorbent.

### BACKGROUND OF INVENTION

Although liquid chromatographic stationary phases and solid phase extraction sorbents enjoy a combined global multi-billion-dollar market, the technology of preparing these materials is still evolving. The instrument hardware and the software controlling chromatographic analysis have experienced tremendous improvements, such as faster data collection rate, minimal instrument breakdown, and steady operational performance, the heart of the system is the liquid chromatographic stationary phases (for separation) and solid phase extraction sorbents (for sample preparation). These materials suffer from a number of shortcomings that include low carbon loading, limited pH stability, poor thermal stability, relatively low surface area, and low average pore width. As a result, the separation capacity in liquid chromatography is still limited compared to gas chromatography. This inherent shortcoming has been addressed by a number of ways, such as ultra-performance liquid chromatography with smaller particle size. However, that approach is limited as it continues to use the same stationary phase synthesis strategy as the larger particle material.

State-of-the-art in synthesizing silica based liquid chromatographic stationary phases and solid phase sorbents traditionally employ spherical solid silica particles as the substrate on the surface upon which a thin layer of stationary phase coating of C8/C18/phenyl/cyano/diol ligands that are grafted via different immobilization techniques. These surface grafting and immobilization processes do not allow high loading of the stationary phases or extraction sorbents on the substrate, generally 10-18% C loadings with the substrate occupying about 80 to 90% the mass of the stationary phases and solid phase extraction sorbents, which limits mass loading of the stationary phases and solid phase extraction sorbents and the separation power of liquid chromatography and the sample capacity of solid phase extraction therefrom.

A nearly exponential growth of the applications of mesoporous silica has occurred in many fields including catalysis, biomedicine, adsorption, column chromatography, drug delivery, and sensors. The development of new strategies for synthesizing mesoporous silica remains a strong research target among materials chemist. Among the many different approaches in synthesizing mesoporous silica, base catalyzed sol-gel reactions using tetraethyl orthosilicate (TEOS) as the inorganic precursor and NH₄OH as the base catalyst are the most common, with sacrificial templates such as polyethylene glycol, block copolymers, and nonionic surfactants used as porogenic agents for ultimate removal by calcination of these sol-gel materials to yield mesoporous silica.

Sol-gel processes are typically carried out with concurrent hydrolysis and condensation processes. When an acid catalyst, such as hydrochloric acid (HCl), trifluoroacetic acid (TFA), or acetic acid, is used hydrolysis proceeds faster than condensation, which results in an open and linear network with relatively little branching. Solvent and sacrificial templates are trapped in the open spaces of the network. As such, removal of solvent and sacrificial templates does not contribute to creation of mesopores. When a base catalyst is used, condensation proceeds rapidly from hydrolyzed functionality and results rapid nucleation and a highly branched particle-like morphology. The particle-like units are very dense and rigidly encapsulate solvents and porogenic templates such that, when the templates are removed by calcination, distinct mesopores in the sol-gel matrix are formed. FIG. 1 shows a stylized morphology of acid catalyzed and base catalyzed sol-gel matrices.

An acid catalyzed followed by base catalyzed sol-gel process has been described in Kabir et al., U.S. Pat. Nos. 9,925,515, 9,925,518, and U.S. patent application Ser. No. 15/818,836. The synthesis of mesoporous silica particles using this dual catalyst approach using an acid catalyst for hydrolysis and a base and/or fluoride catalyst for the polycondensation has not been reported. To this end, the formation of mesoporous silica in this manner is of interest toward the formation of superior mesoporous silica particles, and their applications for liquid chromatographic stationary phases and solid phase extraction sorbents are of great interest.

### BRIEF SUMMARY

In an embodiment of the invention, a mesoporous silica is a gel product of an acid hydrolyzed, base condensed tetraalkoxysilane comprising mixture around a polyethylene glycol porogen after calcination of the porogen that has average pore diameters greater than 50 Å and a surface area in excess of 500 m²/g. The tetraalkoxysilane of the tetraalkoxysilane can be tetramethoxysilane and/or tetraethoxysilane. The mesoporous silica can have a pore volume of 1.0 cm³/g or more.

In an embodiment of the invention, the mesoporous silica is coated by the hydrolysis and condensation of a methyltrialkoxysilane and a substituted trialkoxysilane and/or a hydroxy substituted inorganic or organic polymer to form gel coated mesoporous silica particles. The methyltrialkoxysilane can be methyltrimethoxysilane or methyltriethoxysilane. The substituted trialkoxysilane is one or more selected from: an n-octyltrialkoxysilane; an n-octadecyltrialkoxysilane; a 3-cyanopropyltrialkoxy-silane; an N-trialkoxysilylpropyl-N, N,N-ammonium chloride; and a 3-mercaptopropyltrialkoxysilane, wherein the trialkoxy groups are trimethoxy and/or triethoxy groups. The inorganic or organic polymer comprises polydimethylsiloxane, polytetrahydrofuran, or polyethylene glycol.

In an embodiment of the invention, the gel coated mesoporous silica particles can be a chromatographic stationary phase or a sorbent. The chromatographic stationary phase can be a normal phase liquid chromatograph stationary phase, reverse phase liquid chromatograph stationary phase, mixed-mode liquid chromatograph stationary phase, or a gas chromatography stationary phase. The sorbent can be a solid phase sorbent.

An embodiment of the invention is directed to a method of preparing mesoporous silica particles of the mesoporous silica where one or more tetraalkoxysilanes, a sacrificial template polyethylene glycol, an organic solvent, an acid catalyst, and water are mixed until a particulate comprising fluid forms, from which the particulates are removed and a base and/or fluoride catalyst is added to the liquid to form a porogen-gel solid. The organic liquid can be or include an alcohol. The acid catalyst can be HCl, HF, or trifluoroacetic acid. The porogen-gel solid can be conditioned by the application of heat to form a conditioned porogen-gel solid that upon applying vacuum and heat forms an essentially solvent and reaction byproduct free porogen-gel solid. Upon calcining the solvent and any reaction byproducts, a mesoporous silica mass is formed. The mesoporous silica mass is crushed to form mesoporous silica particles.

An embodiment of the invention is directed to a method of preparing gel coated mesoporous silica particles where mesoporous silica particles are mixed with a liquid freed from precipitate formed from a mixture of at least one methyltrialkoxysilane and at least one substituted trialkoxysilane and/or hydroxy substituted inorganic or organic polymer, at least one solvent an acid catalyst, a solvent to form a coating on the mesoporous silica particles to form the gel coated mesoporous silica particles in a residual liquid. The gel coated mesoporous silica particles are then isolated from the residual liquid. The inorganic or organic polymer can be polydimethylsiloxane, polytetrahydrofuran, or polyethylene glycol. When the substituted trialkoxysilane includes 3-mercaptopropyltrialkoxysilane a step of oxidizing the mercapto functionality to sulfonic acid functionality can be included.

### BRIEF DESCRIPTION OF DRAWINGS

FIG. 1A shows stylized morphology of acid catalyzed silica-porogen sol-gel matrices prior to calcination.

FIG. 1B shows stylized morphology of acid catalyzed silica sol-gel matrices after calcination of the porogen.

FIG. 1C shows stylized morphology of base catalyzed silica-porogen sol-gel matrices prior to calcination.

FIG. 1D shows stylized morphology of base catalyzed silica sol-gel matrices after calcination of the porogen.

FIG. 2 shows a schematic representation of the process for mesoporous silica preparation, according to an embodiment of the invention.

FIG. 3 shows a reaction scheme for the acid catalyzed hydrolysis and base catalyzed condensation to a mesoporous silica, according to an embodiment of the invention.

FIG. 4 shows a schematic representation of the process for gel coated mesoporous silica particles preparation from mesoporous silica, according to embodiments of the invention.

FIG. 5 shows a thermogravimetric analysis plot for C18 comprising coated gel coated mesoporous silica according to an embodiment of the invention.

FIG. 6 shows a bar chart of extraction extent of various analytes for solid phase sorbents, according to an embodiment of the invention, comprising various gel coated mesoporous silica particles in comparison to a commercially available C18 sorbent.

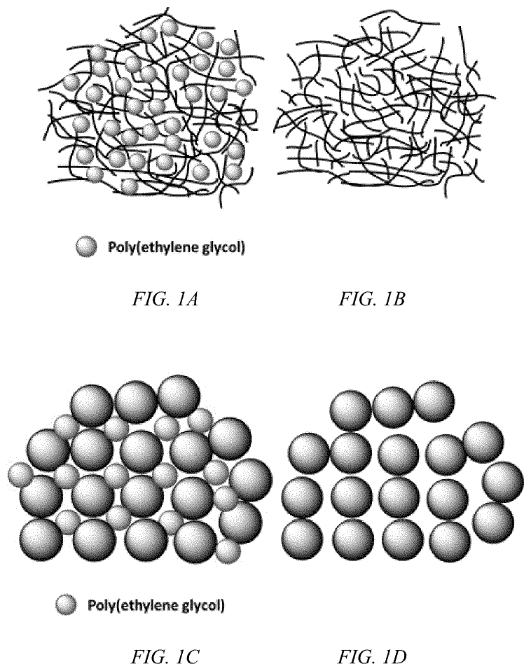

### DETAILED DISCLOSURE

An embodiment of the invention is directed to a two steps synthesis pathway that creates robust liquid chromatographic stationary phases and solid phase extraction sorbents that are characterized by: substantially high surface areas; higher pore volumes; higher average pore widths; substantially increased pH stabilities; and high thermal stability. The synthetic method generates mesoporous silica using poly(ethylene glycol) polymers as the sacrificial template. A sol-gel reaction using acidic catalyst, for example, but not limited to HCl, for hydrolysis and subsequent polycondensation using a basic catalyst, for example, but not limited to, NH₄OH, creates a sol-gel formed silica matrix in the presence of varying amount of poly(ethylene glycol), where during the gelation process a silica network homogeneously entrap poly(ethylene glycol) polymers into its core. Ultimately, upon calcination, the entrapped polymer is burned with creation of mesopores with pore size between 2 and 50 nm pore diameters and micropores with pore sizes smaller than 2 nm in diameter throughout the sol-gel silica matrix. This sponge-like mesoporous silica is coated with: reversed phase organic ligands, such as C18/C8/C4/phenyl; normal phase organic ligands, such as amino/diol/cyano; ion-exchange ligands, such as cation exchange or anion exchange ligands; mixed mode ligands, such as C18/cation-exchange or C18/anion-exchange ligands; or organic polymers with different polarities, such as poly(dimethyl siloxane), poly(ethyl glycol) (PEG), or poly(tetrahydrofuran).

This method of forming mesoporous silica and the resulting solid phases and sorbents, according to embodiments of the invention, provides numerous advantages including: chemically expanding the surface area by creating mesopores and microspores in the sol-gel silica matrix; introducing surface silanol groups that chemically bind the organic ligands/polymers but are not limited to the substrate surface but are distributed on the surface and the inside the mesopores; forming a sponge-like porous architecture of the mesoporous silica particles to allow penetration of a sol solution into its core to chemically bind relatively small organic ligands such as, C3 to C18 comprising substituents, as well as long chain inorganic or organic polymers, such as, but not limited to, poly(dimethyl siloxane), poly(tetrahydrofuran), poly(ethylene glycol) (PEG); introduction of more interaction sites per unit mass of stationary phase/solid phase extraction sorbents to the sponge-like porous architecture of sol-gel mesoporous silica matrix allowing reduction of the organic solvent usage in HPLC and SPE operation; providing an efficient pathway to creation of a large number of SPE sorbents and LC stationary phases; and resulting in sol-gel coated mesoporous materials that demonstrate extraordinary thermal stability, which can extend the range of temperatures used in LC separations past the current maximum of about 60° C. The ability to employ higher temperatures not only can modify interaction mechanisms but allows a reduction of the viscosity of the mobile phase that results in high column backpressures that can allow columns longer than 25 cm to facilitate separation of complex mixtures that are beyond the current limits imposed by the LC column length.

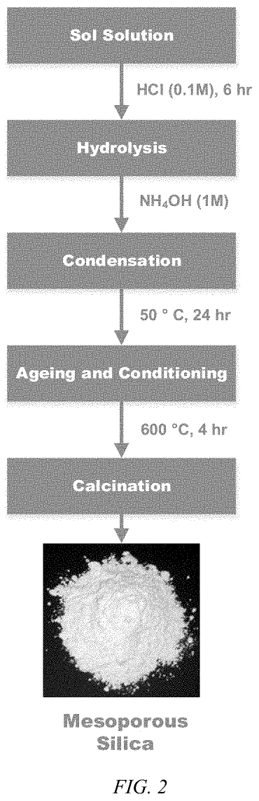

In embodiments of the invention, the mesoporous silica is formed from one or more tetraalkoxysilanes, which can be, but are not limited to, tetramethoxysilane and tetraethoxysilane. Optionally, tetraalkoxysilanes can be used in a polyfunctional silane mixtures with trialkoxysilanes or dialkoxysilanes, as long as the average number of alkoxy groups on the silanes exceeds three, for example 3.1, 3.2, 3.3, 3.4, 3.5, 3.6, 3.7, 3.8, 3.9, and 4.0 or any intermediate value. The mesoporous silica preparation is carried out using any acid catalyst, such as, but not limited to, HCl and trifluoroacetic acid (TFA) for hydrolysis in solution and any base catalyst, including, but not limited to, NH₄OH, or any fluoride containing catalyst, such as, but not limited to NH₄F for the condensation of the hydrolyzed and partially hydrolyzed alkoxysilanes to form a solvent and porogen filled solidified gel. FIG. 2 is a process sequence for the formation of mesoporous silica from a sol solution comprising the tetraalkoxysilane or polyfunctional silane mixture. The calcination to remove the porogen, PEG, can be removed at temperature in excess of 300° C., for example, but not limited to, 600° C., when carried out in air. The solvents can be one or more of any volatile net unreactive organic liquid, such as, but not limited to, an alcohol, ether, or ketone. Examples of the solvent, include, but are not limited to, methanol, ethanol, dichloromethane, tetrahydrofuran, and acetone.

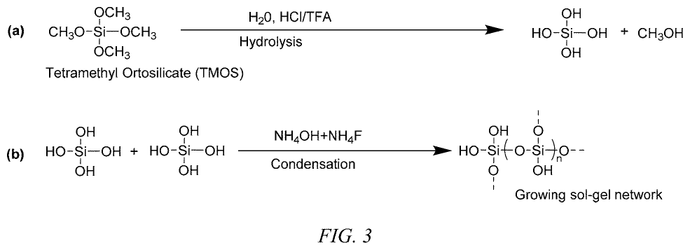

In embodiments of the invention, as shown in the reaction scheme of FIG. 3, a tetramethoxysilane, also known as tetramethyl orthosilicate, hydrolyzes to liberate methanol without a very small extent of silanol condensation in the presence of acid. The hydrolysis is carried out in the presence of poly(ethylene glycol), which will act as a porogen in a subsequent condensation. In the subsequent step, as indicated in FIG. 3, base and/or fluoride promote condensation of the hydrolyzed silanols to form the mesoporous silica network. After removal of solvent and water by evaporation, the calcination of the PEG results in the mesoporous silica. The pore volume of the mesoporous silica network increases with increasing molar ratio of the porogen PEG to tetramethoxysilane up to a ratio to 1. The polar volume decreases when higher ratios of PEG to tetramethoxysilane are used.

By using the acid catalyzed hydrolysis subsequent base catalyzed condensation process, according to embodiments of the invention, the pore size and volume increases substantially over that where there is acid catalyzed condensation. As shown in Tables 1 and 2, the porogen does not promote a significant increase in pore size, the pore width or diameter, or pore volume with porogen content, whereas the base catalyzed condensation results in a significant increase in pore volume that is independent of porogen to tetraalkyloxysilane ratio and is 1.0 to two significant figures, with a pore size that increases significantly until the porogen to tetraalkyloxysilane ratio increases to 1.

TABLE 1
Acid Catalyzed Mesoporous Silica

| | | | BJH | BJH | | Average |
|---|---|---|---|---|---|---|
| | PEG/ | BET | Adsorption | Desorption | Pore | Pore |
| Sorbent | TMOS | Surface Area | Surface Area | Surface Area | Volume | Width |
| Number | ratio | (m²/g) | (m²/g) | (m²/g) | (cm³/g) | (Å) |
| Silica-1 | 1:0 | 740.0198 | 755.019 | 760.2292 | 0.592526 | 32.0276 |
| Silica-2 | 1:0.31 | 692.5205 | 718.703 | 733.8472 | 0.570395 | 32.9460 |
| Silica-3 | 1:0.63 | 540.6427 | 445.896 | 580.8417 | 0.444271 | 32.8698 |
| Silica-4 | 1:1 | 498.7032 | 433.353 | 470.8504 | 0.410966 | 32.9627 |
| Silica-5 | 1:1.25 | 477.9652 | 426.315 | 451.1171 | 0.387735 | 32.4488 |

TABLE 2
Acid-Base Catalyzed Mesoporous Silica

| | | | BJH | BJH | | Average |
|---|---|---|---|---|---|---|
| | PEG/ | BET | Adsorption | Desorption | Pore | Pore |
| Sorbent | TMOS | Surface Area | Surface Area | Surface Area | Volume | Width |
| Number | ratio | (m²/g) | (m²/g) | (m²/g) | (cm³/g) | (Å) |
| Silica-6 | 1:0 | 767.3794 | 786.944 | 879.5397 | 1.021044 | 53.2224 |
| Silica-7 | 1:0.31 | 662.8445 | 713.721 | 785.1940 | 1.058725 | 63.6698 |
| Silica-8 | 1:0.63 | 564.2251 | 594.387 | 657.0121 | 0.981046 | 69.5500 |
| Silica-9 | 1:1 | 569.5993 | 604.153 | 667.2249 | 1.128006 | 79.2140 |
| Silica-10 | 1:1.25 | 527.1253 | 542.904 | 606.4942 | 0.756249 | 55.7190 |

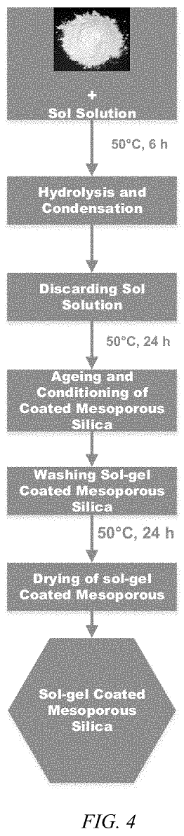

Subsequent to calcination, as shown in FIG. 4, the mesoporous silica can be surface functionalized by sol-gel formed gel coating with at least one organo trialkoxy silane, for example, but not limited to, an alkyl trialkoxysilane or an aryl trialkoxy silane, where the alkyl or aryl group can be further substituted with a functional group. In this process, the organo trialkoxy silane hydrolyzes and condenses with silanol groups of the mesoporous silica and of the hydrolysis products of the organo trialkoxy silane. In this manner, the number of substituents attached to the surface of the gel coated mesoporous silica exceeds the residual silanols of the mesoporous silica, unlike that of typical state of the art chromatography stationary phases and sorbents. In this manner, new functionalized mesoporous silica, organically modified silica, can be formed that have, for example, but not limited to, functionality comprising one or more of, octadecyl groups, octyl groups, cyanopropyl groups, phenyl groups, and an inorganic or organic polymer, such as, but not limited to, hydroxyl terminated polydimethylsiloxane polytetrahydrofuran or polyethylene glycol, for use as chromatographic stationary phases and solid phase extraction sorbents. The alkoxy group can be methoxy, ethoxy, or higher alkoxy groups, such as, but not limited to n-propoxy, iso-propoxy, n-butoxy, or sec-butoxy groups. A non-exhaustive list of organo trialkoxy silanes includes: n-octyltrimethoxysilane; n-octadecyltrimethoxysilane; 3-cyanopropyltrimethoxy-silane; N-trimethoxysilylpropyl-N,N,N-ammonium chloride; and 3-mercaptopropyltrimethoxysilane. Additionally, methyl trimethoxy silane can be included as one of a mixture of organo trialkoxy silanes.

In an embodiment of the invention, the gel coated mesoporous silica comprises a stationary phase for a chromatographic separation or as a sorbent to absorb a molecule of interest, such as, but not limited to an analyte for its determination in a fluid such as water, organic solvent, air, or other gas. The gel coated mesoporous silica stationary phase resides in a column or tube through which a mobile phase liquid or gas is passed during a chromatographic process. According to an embodiment of the invention, gel coated mesoporous silica stationary phases can be used for liquid chromatography in a normal phase, reverse phase, or mixed-mode, for gas chromatography, or as a solid phase sorbent. Advantageously, the gel coated mesoporous silica stationary phase or solid phase sorbent has excellent stability to temperature, solvents, and acids and bases relative to common commercially available sorbents with equivalent functionality that are attached to a substrate other than by sol-gel coating of a mesoporous silica. As indicated in Table 3, below, for the C18 gel coating on mesoporous silica prepared as indicated in Table 6, below, relative to the commercial C18 sorbent: Supelco Discovery DSC-18 SPE.

TABLE 3
Physicochemical Characteristics of C18 comprising gel coated
mesoporous silica and a commercial C18 comprising sorbent

| | | | | pH | Thermal |
|---|---|---|---|---|---|
| | Carbon | BET Surface | Pore | Stability | Stability |
| Sorbent | Loading | Area (m²/g) | Width (Å) | range | (° C.) |
| Commercial C18 | 11-18% | 480 | 70 | 2-8 | 60 |
| Mesoporous C18 | >30% | 667 | 80 | 1-12 | 400 |

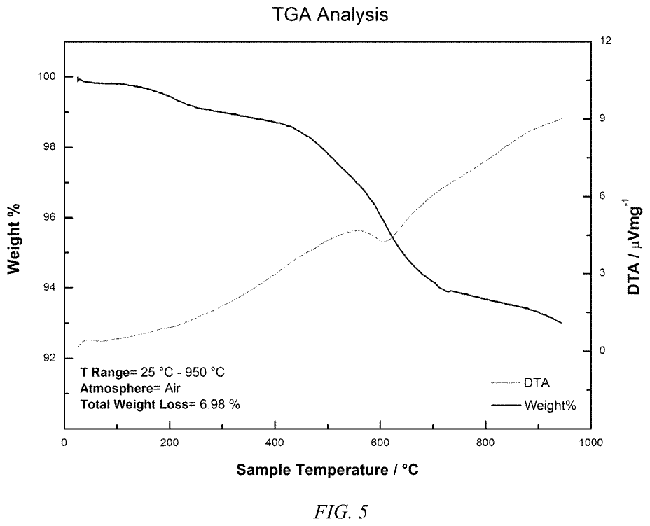

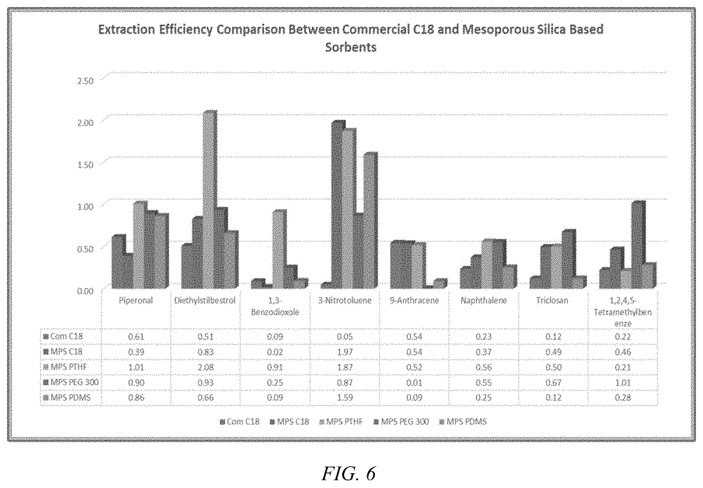

The thermal stability allows the gel coated mesoporous silica allows the sorbent or stationary phase to be used at temperatures in excess of 100° C., or even 200° C. in many cases, where, as can be seen in FIG. 5 that no significant weight loss, less than 2% weight loss, is seen with a carbon loading of more than 30% until 400° C. is exceeded. Particularly at high pH, the gel coated mesoporous silica provides much higher capabilities for aqueous based adsorption or chromatographic uses. Ion-exchange can be carried out using the sol-gel coated mesoporous silica where anionic or cationic exchanging ion comprising functionality are on or can be formed from the substituted trialkoxy silanes employed to form the gel coating on the mesoporous silica. The gel coated mesoporous silica per volume has excellent extraction efficiencies as compared to commercially available C18 silica sorbent, as shown in FIG. 6 for the compounds of Table 4, below.

TABLE 4
Compounds absorbed on gel coated mesoporous silica comprising
sorbents and a commercial C18 sorbent of FIG. 6

| | Molecular | |
|---|---|---|
| Compound | Weight | Log K_{ow} |
| Piperonal | 150.13 | 1.05 |
| Benzodioxole | 122.12 | 2.08 |
| 4-Nitrotoluene | 137.14 | 2.45 |
| 9-Anthracene Methanol | 208.26 | 3.04 |
| Naphthalene | 128.17 | 3.35 |
| 1,2,4,5-Tetramethol Benzene | 134.22 | 4.00 |
| Triclosan | 289.54 | 4.53 |
| Diethylstilbestrol | 268.35 | 5.07 |

The commercial C18 sorbent and the mesoporous silica sorbents, including a sol-gel mesoporous silica C18 sorbent, have extraction efficiencies determine by exposing 50 mg of each sorbents to 10 mL aqueous solutions of the individual test compounds of Table 4 at a concentration of 1 μg/mL. The amount of extracted analytes by each of the sorbent was calculated by subtracting the chromatographic area count for each analyte in the solution before and after the extraction. As can be seen in FIG. 6, all the test compounds were extracted at significantly higher mass compared to commercial C18. Commercial C18 sorbents possess variable amount of surface silanol groups due to incomplete end-capping and are often capable of extracting relatively polar analytes. However, the sol-gel mesoporous silica C18 sorbent does not possess significant amount of residual surface silanol group and does not extract polar analytes effectively. The absence of residual surface silanol group in mesoporous silica sorbents is advantageous for the analysis of organic bases.

### Methods and Materials

### Hydrofluoric Acid Catalyzed Mesoporous Silica

TABLE 5
Mesoporous Silica Reagents

| Chemical | Role | Molar Ratios |
|---|---|---|
| Tetramethyl | Silica network | 1 |
| Orthosilicate (TMOS) | reagent | |
| Poly(ethylene | Sacrificial template | 0; 0.31; 0.63; |
| glycol) (PEG) | | 1.0; 1.25 |
| Methanol | Solvent | 20 |
| HF (0.1M in water) | Catalyst and reagent | 4 (water) |

Tetramethyl orthosilicate, poly(ethylene glycol) and methanol were weighed/measured into a 50 mL reaction vessel and mixed on a vortex mixer to form a sol solution. Subsequently, the catalyst (0.1 M HF) was added to the sol solution and the solution was kept at room temperature until gelation occurs. The gelled silica matrix was conditioned at 50° C. for 24 h. Subsequently, the gelled silica matrix was dried in a vacuum oven at 80° C. for 24 h. The dried sol-gel particles were then calcined for 4 h at 600° C. to remove the PEG. The mesoporous silica was crushed and ground in a mortar to form fine particles.

### Acid-Base Dual Catalyzed Mesoporous Silica

TABLE 6
Acid-Base/Fluoride Catalyzed Mesoporous Silica Reagents

| Chemical | Role | Molar Ratios |
|---|---|---|
| TMOS | Silica networking | 1 |
| | reagent | |
| PEG | Sacrificial | 0; 0.31; 0.63; |
| | template | 1.0; 1.25 |
| Methanol | Solvent | 20 |
| HCl (0.1M in water) | Catalyst and reagent | 4 (water) |
| NH₄OH/NH₄F (0.25M/0.025M | Catalyst | 1.57 (solvent) |
| in 2-propanol) | | |

TMOS, PEG, methanol are weighed and placed into a 50 mL reaction vessel and mixed on a vortex mixer. Subsequently, the acid catalyst was added to the sol solution and the solution was kept at 50° C. for hydrolysis. At the end of the hydrolysis, ammonium hydroxide/ammonium fluoride catalyst mixture (0.1M, 0.01 M, respectively) was added to the sol solution. The sol solution converted into gel soon after adding the base/fluoride catalyst mixture. The gelled silica matrix was conditioned at 50° C. for 24 h. Subsequently, the gelled silica matrix was dried in a vacuum oven at 80° C. for 24 h. The dried sol-gel matrix was calcined for 4 h at 600° C. to remove the PEG. The mesoporous silica was crushed and ground in a mortar to form fine particles.

### C18 Reversed Phase Coating on Mesoporous Silica Substrate

TABLE 7
Reagents for Coating (C18)

| Chemical | Role | Mass/Volume | |
|---|---|---|---|
| Mesoporous Silica | Silica substrate | 1.0 | g |
| Methyl | Coating precursor | 12.5 | mL |
| Trimethoxysilane (MTMOS) | | | |
| n-Octadecyltrimethoxysilane | Ligand Coating precursor | 12.5 | g |
| Dichloromethane | Solvent | 12.5 | mL |
| Acetone | Solvent | 12.5 | mL |
| Trifluoroacetic | Acid catalyst and reagent | 5 | mL |
| acid (5% water) | | | |

A sol solution was prepared by weighing or pipetting MTMOS, n-Octadecyltrimethoxysilane (C18-TMS), dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Cyano Reversed Phase Coating on Mesoporous Silica Substrate

TABLE 8
Reagents for Coating (Cyano)

| Chemical | Role | Mass/Volume | |
|---|---|---|---|
| Mesoporous Silica | Silica substrate | 1.0 | g |
| MTMOS | Coating precursor | 12.5 | mL |
| 3-cyanooctadecyltrimethoxysilane | Ligand Coating | 12.5 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, 3-cyanooctadecyltrimethoxysilane, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded, and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Anion Exchanging Coating on Mesoporous Silica Substrate

TABLE 9
Reagents for Coating (Anionic Exchange)

| Chemical | Role | Mass/Volume | |
|---|---|---|---|
| Mesoporous Silica | Silica substrate | 1.0 | g |
| MTMOS | Coating precursor | 12.5 | mL |
| N-Trimethoxysilylpropyl-N,N,N- | Ligand Coating | 12.5 | g |
| ammonium chloride | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, N-trimethoxysilylpropyl-N,N,N-ammonium chloride, dichloromethane and acetone into a 50 mL, reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Cation Exchanging Coating on Mesoporous Silica Substrate

TABLE 10
Reagents for Coating (Cationic Exchange)

| Chemical | Role | Mass/Volume | |
|---|---|---|---|
| Mesoporous Silica | Silica substrate | 1.0 | g |
| MTMOS | Coating precursor | 12.5 | mL |
| 3-Mercaptopropyltrimethoxysilane | Ligand Coating | 12.5 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, 3-mercaptopropyltrimethoxysilane, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h. The dried sol-gel coated mesoporous silica was then treated with 30% H₂O₂ for 24 h and 0.05 M H₂SO₄ for 2 h for oxidation. The mercaptopropyl functional group converts to a propyl sulfonic group upon oxidation.

### Mixed Mode (Neutral and Anion Exchanging) Coating on Mesoporous Silica Substrate

TABLE 11
Reagents for Coating (Anionic Exchange Mixed Mode)

| Chemical | Role | Mass/Volume | |
|---|---|---|---|
| Mesoporous Silica | Silica substrate | 1.0 | g |
| MTMOS | Coating precursor | 12.5 | mL |
| n-Octadecyltrimethoxysilane | Ligand Coating | 6.25 | g |
| | precursor | | |
| N-Trimethoxysilylpropyl-N,N,N- | Ligand Coating | 6.25 | g |
| ammonium chloride | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, n-Octadecyltrimethoxysilane, N-Trimethoxysilylpropyl-N,N,N-ammonium chloride, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Mixed Mode (Neutral and Cation Exchanging) Coating on Mesoporous Silica Substrate

TABLE 12
Reagents for Coating (Cationic Exchange Mixed Mode)

| Chemical | Role | Mass/Volume | |
|---|---|---|---|
| Mesoporous Silica | Silica substrate | 1.0 | g |
| MTMOS | Coating precursor | 12.5 | mL |
| n-Octadecyltrimethoxysilane | Ligand Coating | 6.25 | g |
| | precursor | | |
| 3-Mercaptopropyltrimethoxysilane | Ligand Coating | 6.25 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, n-octadecyltrimethoxysilane, 3-Mercaptopropyltrimethoxysilane, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. The sol-gel coated mesoporous silica was dried in a vacuum drier for 24 h. The dried sol-gel coated mesoporous silica was then treated with 30% H₂O₂ for 24 h and 0.05 M H₂SO₄ for 2 h for oxidation. The mercaptopropyl functional group converts to propyl sulfonic group upon oxidation.

### Inorganic Polymeric Coating: Polydimethylsiloxane

TABLE 13
Reagents for Coating (Inorganic Polymer)

| Chemical | Role | Mass/Volume | |
|---|---|---|---|
| Mesoporous Silica | Silica substrate | 1.0 | g |
| MTMOS | Coating precursor | 12.5 | mL |
| Polydimethylsiloxane | Polymer Coating | 12.5 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, polydimethylsiloxane, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded, and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Organic Polymeric Coating: Polytetrahydrofuran

TABLE 14
Reagents for Coating (Organic Polymer)

| Chemical | Role | Mass/Volume | |
|---|---|---|---|
| Mesoporous Silica | Silica substrate | 1.0 | g |
| MTMOS | Coating precursor | 12.5 | mL |
| Polytetrahydrofuran | Polymer Coating | 12.5 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, polytetrahydrofuran, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded, and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

### Organic Polymeric Coating: PEG

TABLE 15
Reagents for Coating (Organic Polymer)

| Chemical | Role | Mass/Volume | |
|---|---|---|---|
| Mesoporous Silica | Silica substrate | 1.0 | g |
| MTMOS | Coating precursor | 12.5 | mL |
| PEG | Polymer Coating | 12.5 | g |
| | precursor | | |
| Dichloromethane | Solvent | 12.5 | mL |
| Acetone | Solvent | 12.5 | mL |
| Trifluoroacetic | Acid catalyst | 5 | mL |
| acid (5% water) | and reagent | | |

A sol solution was prepared by weighing or pipetting MTMOS, PEG, dichloromethane and acetone into a 50 mL reaction vessel. The solution was vortexed for 3 min and subsequently, trifluoroacetic acid (5% water) was added to the sol solution. The solution was centrifuged for 5 min to remove particulate matters. The supernatant was transferred to a second reaction vessel. Mesoporous silica was added to the supernatant in the second reaction vessel. The reaction vessel was kept at 50° C. in an oil bath for 6 h. Subsequently, the liquid was discarded, and the mesoporous silica coated with sol-gel tetrahydrofuran was conditioned at 50° C. overnight in an inert environment. The sol-gel coated mesoporous silica was then washed with methanol/methylene chloride (50:50 v/v) under sonication. Finally, the sol-gel coated mesoporous silica was dried in a vacuum drier for 24 h.

All patents and patent applications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A mesoporous silica particle, produced by an acid hydrolysis subsequent base condensation process, with average pore diameter greater than 50 Å but less than 80 Å, pore volume greater than or equal to 1.0 cm³/g and a surface area in excess of 500 m²/g, wherein the acid hydrolysis subsequent base condensation process comprises:
mixing one or more tetraalkoxysilanes, polyethylene glycol, and at least one acid catalyst to form a hydrolysis mixture;
adding a base catalyst to form a porogen-gel solid; and
calcining the porogen-gel solid to form the mesoporous silica particle.

2. The mesoporous silica particle according to claim 1, the one or more tetraalkoxysilanes being tetramethoxysilane and/or tetraethoxysilane.

3. (canceled)

4. A gel coated mesoporous silica particle, comprising the mesoporous silica particle according to claim 1, and a coating thereon from the hydrolysis and condensation of methyltrialkoxysilanes and substituted trialkoxysilanes and/or a hydroxy substituted inorganic polymer or a hydroxy substituted organic polymer.

5. The gel coated mesoporous silica particle according to claim 4, wherein the methyltrialkoxysilane is methyltrimethoxysilane or methyltriethoxysilane.

6. The gel coated mesoporous silica particle according to claim 4, wherein the substituted trialkoxysilane is one or more selected from: an n-octyltrialkoxysilane; an n-octadecyltrialkoxysilane; a 3-cyanopropyltrialkoxy-silane; an N-trialkoxysilylpropyl-N,N,N-ammonium chloride; and a 3-mercaptopropyltrialkoxysilane, wherein the trialkoxy groups are trimethoxy and/or triethoxy groups.

7. The gel coated mesoporous silica particle according to claim 4, wherein the inorganic or organic polymer comprises polydimethylsiloxane, polytetrahydrofuran, or polyethylene glycol.

8. A chromatographic stationary phase or sorbent, comprising the gel coated mesoporous silica particle according to claim 4.

9. The chromatographic stationary phase or sorbent according to claim 8, wherein the chromatographic stationary phase is a normal phase liquid chromatograph stationary phase, reverse phase liquid chromatograph stationary phase, mixed-mode liquid chromatograph stationary phase, or a gas chromatography stationary phase.

10. The chromatographic stationary phase or sorbent according to claim 8, wherein the sorbent is a solid phase sorbent.

11. A method of preparing mesoporous silica particle according to claim 1, comprising:
providing one or more tetraalkoxysilanes;
providing polyethylene glycol as a sacrificial template;
providing a solvent comprising at least one organic liquid;
providing at least one acid catalyst and water;
mixing the tetraalkoxysilanes, the polyethylene glycol, the solvent, the acid catalyst and the water to form a hydrolysis mixture;
observing the hydrolysis mixture until a particulate comprising fluid forms;
separating particulates from a liquid of the particulate comprising fluid;
adding a base and/or fluoride catalyst to the liquid to form a porogen-gel solid;
conditioning the porogen-gel solid by the application of heat to form a conditioned porogen-gel solid;
applying vacuum and heat to the conditioned porogen-gel solid, to form an essentially solvent and reaction byproduct free porogen-gel solid;
calcining the solvent and reaction byproduct free porogen-gel solid to form a mesoporous silica mass; and
crushing the mesoporous silica mass to mesoporous silica particles.

12. The method according to claim 11, wherein the tetraalkoxysilane is tetramethoxysilane and/or tetraethoxysilane.

13. The method according to claim 11, wherein the organic liquid comprises an alcohol.

14. The method according to claim 11, wherein the acid catalyst comprises HCl, HF, or trifluoroacetic acid.

15. The method according to claim 11, wherein separating comprises centrifugation or filtering.

16. A method of preparing gel coated mesoporous silica particle according to claim 4 comprising:
providing mesoporous silica particles prepared according to claim 11;
providing at least one methyltrialkoxysilane and at least one substituted trialkoxysilane and/or hydroxy substituted inorganic or organic polymer;
providing at least one solvent;
providing an acid catalyst;
providing a solvent;
mixing the solvent, the acid catalyst, the methyltrialkoxysilane, and the substituted trialkoxysilane and/or hydroxy substituted inorganic or organic polymer until some precipitate forms in a liquid;
separating the precipitate from the liquid;
adding the mesoporous silica particles to the liquid to condense a coating on the mesoporous silica particles to faun the gel coated mesoporous silica particles in a residual liquid; and
isolating the gel coated mesoporous silica particles from the residual liquid.

17. The method according to claim 16, wherein the methyltrialkoxysilane is methyltrimethoxysilane or methyltriethoxysilane.

18. The method according to claim 16, wherein the substituted trialkoxysilane is one or more selected from: an n-octyltrialkoxysilane; an n-octadecyltrialkoxysilane; a 3-cyanopropyltrialkoxy-silane; an N-trialkoxysilylpropyl-N,N,N-ammonium chloride; and a 3-mercaptopropyltrialkoxysilane, wherein the trialkoxy groups are trimethoxy and/or triethoxy groups.

19. The method according to claim 16, wherein the inorganic or organic polymer comprises polydimethylsiloxane, polytetrahydrofuran, or polyethylene glycol.

20. The method according to claim 16, wherein the substituted trialkoxysilane comprises 3-mercaptopropyltrialkoxysilane, and further comprising oxidizing mercapto functionality to sulfonic acid functionality.

21. The mesoporous silica particle according to claim 1, the acid catalyst being HCl, HF and/or trifluoroacetic acid (TFA).
